(19) United States
(12) Patent Application Publication
(10) Pub. No.: US 2003/0144934 A1
(43) Pub. Date: Jul. 31, 2003

(54) System and method for valuing financial asset services and financial asset service agreements

(75) Inventor: Randolph Fowler Totten, Richmond, VA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: Hunton & Williams

(21) Appl. No.: 10/058,318

(22) Filed: Jan. 30, 2002

(51) Int. Cl. G06F 17/60

(52) U.S. Cl. 705/35

(57) ABSTRACT

A method and system for valuation of financial asset services and financial asset service agreements, wherein the financial asset services are valued as a percentage of all payments paid or payable on a financial asset. The system and method comprise determining total amounts payable and compensating a servicer to collect and disburse funds of the financial asset. The financial asset service valuation component stabilizes the income of the financial asset service provider under a financial asset service agreement and further stabilizes the value of the financial asset service agreement as an asset of the service provider.

### FIELD OF THE INVENTION

The present invention relates generally to systems and methods for valuing financial asset services and for valuing associated financial asset service agreements.

### BACKGROUND OF THE INVENTION

Mortgage loans are the largest category of financial assets and it is easiest to describe and understand the invention in the context of a specific category of financial assets.

The last two decades have seen a revolution in the way mortgage loans are financed, with a shift of investment capital and mortgage assets from traditional lending and savings institutions to capital market investors. Before the financial crash of the savings and loan industry in the early 1980s, home purchasers typically gave a note, as evidence of a loan, to a local bank, which financed the loan with deposits. The bank held the loan and collected interest from the home purchaser in an amount adequate to pay its expenses, pay its depositors and provide it with a return on its own investment capital.

With the demise of the savings and loan industry, a new source of capital was required to finance residential mortgage loans. Capital market investors were available to provide financing but desired liquidity for their investment. For example, pension plans would want to be able to sell the mortgage loans to provide funds to make payments to pensioners and, if the capital investors are investors in a mutual fund, the mutual fund would like to be able to sell the mortgage loans to make payments to shareholders seeking to redeem their mutual fund stock. To obtain that liquidity at an efficient cost, the mortgage loans were converted into freely marketable securities.

A mortgage loan security industry was developed to provide loans to home purchasers from funds available from capital market investors. Today it is customary for an entity that actually makes mortgage loans (an originator) to sell its mortgage loans to an accumulator/securitizer. The accumulator/securitizer deposits the mortgage loans in a trust (a securitization trust) in exchange for mortgage-backed securities issued by the securitization trust. The securitization trust obtains credit enhancement contracts to insure the mortgage loans against the risk that the home purchaser becomes unable to pay and obtains service contracts which insure that the securitization trust will receive timely payment if the home purchaser fails to pay even though capable of payment. Because of these securitization contracts of which the securitization trust is a beneficiary, the securities carry very little credit risk and are highly rated by rating agencies who have reviewed the mortgage loans and transaction structure. The cost of required servicing of the mortgage loans is typically paid from the payments made on the mortgage loans.

The accumulator/securitizer sells the highly rated securities to investment banking firms that in turn sell them to capital market investors. In this manner mortgage funds are provided by the capital market investors to home purchasers and persons who use the value of their existing home to borrow mortgage funds. As of Dec. 31, 2000, there were more than $2 trillion of mortgage-backed securities outstanding in capital markets.

Beginning with the date a particular mortgage loan is originated, the mortgage loan must be “serviced.” In order to service the mortgage loan, payments must be collected from the home purchaser/borrower and accounted for, property taxes paid, private mortgage and homeowners insurance maintained, home inspection appraisals made, and appropriate disbursements made. As ownership of mortgage loans has been transferred from traditional institutional lenders to capital market investors, the mortgage loan servicer has become critical to the success of the mortgage loan industry.

Through the securitization trust, capital markets investors who own the loans are the beneficiaries of a servicing agreement. Under a servicing agreement a financial asset services provider agrees to service the mortgage loans in the securitization trust for the benefit of the capital markets investors. Among the obligations of the servicer is typically an obligation to “advance” for delinquencies by debtors in meeting their payment obligations, making payments to the lender on behalf of the debtor. Advances are required to assure the timely payment of the securities backed by the mortgage loans in order that those securities can be highly rated.

When the mortgage loan is serviced by the entity that owns the loan, the owner simply pays the expense of servicing the loan from its gross income, the interest payments, on the mortgage loan. The mortgage loan industry and its reliance on capital market investors has separated servicing from ownership. Understandably, the business entities that provide the servicing make a commitment to make necessary advances and charge a fee. As was the case when ownership and servicing were not separated, the servicing fee has been paid from the interest income on the mortgage loan. In the present market that fee is based on a percentage of the principal outstanding on the mortgage loan.

Servicing fees are based primarily on the cost of servicing as a percentage of the loan amount being serviced, but also vary with other factors, including rating agency's requirements. For this reason, the expected cost of servicing may be significantly less than the servicing fee and the right to service the loans for the servicing fee has significant value. That value is taken into account in all mortgage loan industry transactions.

For illustrative purposes, assume a servicing fee of 25 basis points, or 0.25% per annum of the principal amount of the loan outstanding from time to time. On a $100,000 loan, the servicing fee for that loan for the first month would be 0.25% times $100,000, divided by 12, or $20.83. If at the end of the first month the borrower paid the loan down by $50,000, the servicing fee for the second month would be cut in half to $10.42 because the principal amount of the loan had been cut in half.

To finish the example, assume the interest rate on the mortgage loan is 8% and the cost of credit enhancement and other securitization expenses are 0.50%. The interest available for the capital market investors on their $100,000 investment in the loan would be calculated by subtracting the servicing fee and the cost credit enhancement fee and all other securitization expenses from the interest rate on the mortgage loan, 8%−0.25%−0.50%=7.25% per annum in this example. That is, the servicing would have a value of 0.15% per annum. With that value, a market has developed for servicing agreements with one service provider paying another for the right to service the loans for the servicing fee.

The current servicing fee structure seems logical and works for capital market investor purposes because a constant instant rate is available to pay interest on the securities backed by the related mortgage loans. Yet there are several problems that make the fee structure inefficient from the perspective of the mortgage loan services provider. As noted in the example above, the value of the servicing fee in the typical case exceeds the cost of servicing. That excess value is an asset of the mortgage loan servicer. Yet mortgage loan servicers have a very difficult time utilizing that value because the value is uncertain and developments in the mortgage market have made that value even more uncertain now than it has been in the past.

The fee that the mortgage loan servicer receives for servicing a group of mortgage loans is directly related to the principal amount of the loans outstanding. That is, 0.25% times $100 million principal amount of loans is twice the fee for 0.25% times $50 million principal amount of loans outstanding. Yet a pool of $100 million of loans can pay down by $50 million or more in very short order if prevailing interest rates decline below the rates owed on the loans. When prevailing mortgage rates decline borrowers often pay down their existing loans with new loans at lower rates. The consequence is that the mortgage loan servicer loses the fee income on the loans that are paid down. The problem for the mortgage loan servicer is compounded by the fact that servicing costs are highest for setting the loan up on the servicer's systems at origination. Furthermore, as the mortgage market has gotten more efficient in refinancing mortgage loans, even slight declines in interest rates can result in significant prepayments of outstanding mortgage loans.

Because the value of mortgage loan service agreements is very uncertain, it is very difficult for mortgage loan servicers to borrow or otherwise raise capital against that value. For example, lenders are hesitant to lend money that can only be repaid from servicing fees that would vanish in the event the loans being serviced were prepaid.

Even in the absence of some need to acquire financing, the uncertainty of the value of servicing also creates accounting problems for servicers. Servicing values can fluctuate greatly from time to time as market conditions and projections of prepayments change. When the value of the servicing is carried as an asset on the financial statements of the servicer, the fluctuation in value is reflected in the financial statements. Investors and management prefer stable values, which would be better provided by the servicing fee structure embodied in the invention than by the current servicing fee structures.

### SUMMARY OF THE INVENTION

An object of the present invention is to overcome these drawbacks in existing systems and methods.

Another object of the invention is to provide a system and methodology for valuing financial asset services.

Yet another object of the invention is to provide a system and methodology for valuing agreements to perform financial asset services.

Still another object of the invention is to provide a system and methodology for stabilizing the value of financial asset service agreements.

Another object of the invention is to provide a system and methodology to create a vehicle so that financial asset service providers can more easily borrow or otherwise raise capital against the value of a financial asset service agreement.

An additional object of the invention is to provide a system and methodology to create a vehicle so that financial asset service providers can more stably and more readily carry financial asset service agreements an assets on financial statements.

Still another object of the invention is to provide a system and methodology so that an actual financial asset services value is closer to the expected financial asset services value.

Another object of the invention is to provide a system and methodology to create a vehicle so that the interests of the financial asset service provider and the creditor are more closely aligned.

Other objects and advantages exist for the present invention.

### BRIEF DESCRIPTION OF THE DRAWINGS

FIG. 1 is a schematic representation of a system for valuation of financial asset services and financial asset service agreements according to one embodiment of the present invention.

FIG. 2a is a flow diagram showing a process for valuing financial asset service agreements before financial asset services are provided according to one embodiment of the present invention.

FIG. 2b is a flow diagram showing a process for valuing financial asset service agreements after financial asset services have been provided according to one embodiment of the present invention.

### DETAILED DESCRIPTION OF THE PREFERRED EMBODIMENTS

The present invention is described in relation to systems and methods for the valuation of financial asset services and financial asset service agreements. The characteristics and parameters pertaining to the systems and methods are applicable to all financial assets, defined as the right of one person or group of persons to receive payment in the future from another person or group of persons. Although the invention is particularly applicable and valuable to securitization transactions in which securities: (i) are created that are based on and backed by payments due on a pool of financial assets, (ii) are enhanced by eliminating some associated credit risks, and (iii) sold to passive capital market investors. The invention, however, is equally applicable to any circumstance in which one person pays another person to service or otherwise enhance the value of a financial asset.

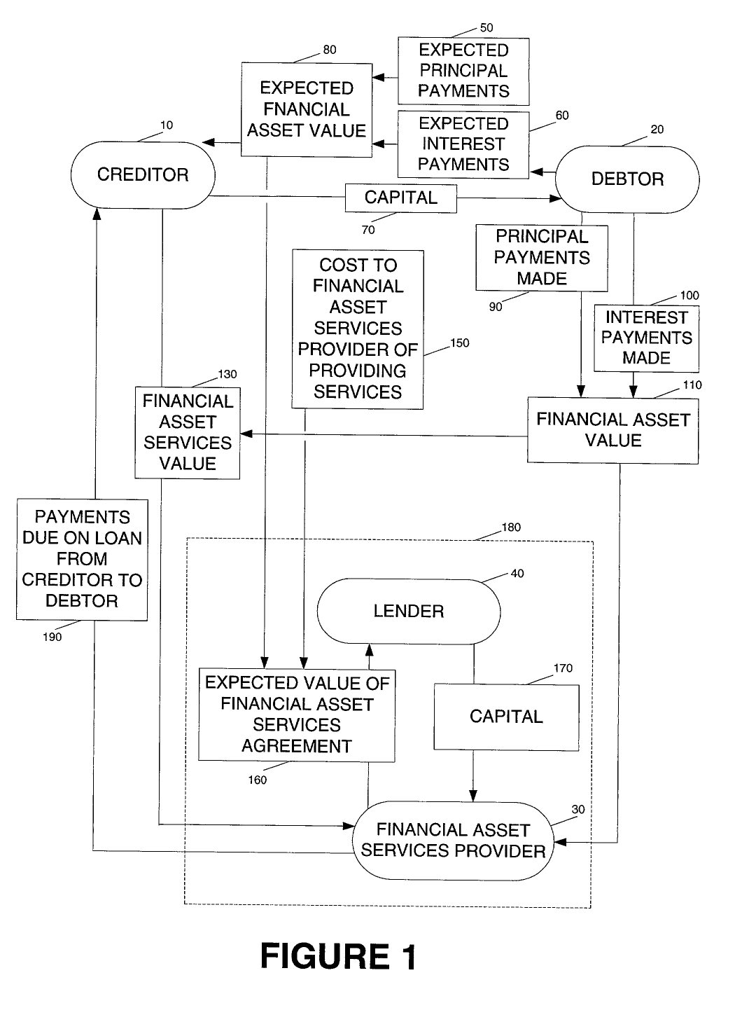

FIG. 1 is a schematic representation of a system implementing an embodiment of the invention. According to a preferred embodiment of the invention, the system may comprise a creditor 10, a debtor 20, a financial asset service provider 30, a lender 40, a financial asset valuation component 110, a servicing component 190, a financial asset service valuation component 120, and a financial asset service agreement valuation component 140. For illustration purposes only, the present invention as embodied in FIG., 1 depicts one creditor 10, one debtor 20, one financial asset service provider 30, and one lender 40. However, any number of creditors 10, debtors 20, financial asset service providers 30, and lenders 40 may be employed in connection with the implementation of the present invention.

Debtor 20 may take out a loan from creditor 10. According to an embodiment of the invention, creditor 10 is entitled to receive repayment of the principal 50 and payments of interest 60 from debtor 20. Creditor 10 may enter into an agreement with financial asset services provider 30 to service the loan made by creditor 10 to debtor 20. Obligations of servicing the loan may include calculating payments due from debtor 20 to creditor 10, collecting all payments due from debtor 20 to creditor 10, accounting for payments of debtor 20 to creditor 10, paying taxes on behalf of debtor 20, maintaining insurance policies in connection with the loan, and advancing creditor 10 funds for failures of debtor 20 to make payments due under the loan. The financial asset services provider 30 may be compensated by the creditor 10 for services provided under a financial asset services agreement in an amount equal to the financial asset services value 130.

According to a preferred embodiment of the invention, the financial asset services value 130 is determined by totaling the principal payments made 90 and the interest payments made 100 on the loan being serviced and calculating a percentage or portion thereof 120. According to an embodiment of the invention, the financial asset services value 130 may be incorporated as a term in the financial asset services agreement.

According to an embodiment of the invention, the financial asset services provider 30 may use the expected financial asset services value 130 as an asset in its bookkeeping. The financial asset service provider 30 may also utilize the expected financial asset services value 130 for securing financing 180. In a preferred embodiment of the invention a financial asset service provider 30 may approach a lender 40 and obtain capital 170 based on the expected value of the financial asset services agreement 160. The expected value of the financial asset services agreement 160 may be the expected financial asset services value 80 minus the cost to financial asset provider of providing services 150. According to an embodiment of the invention a lender 40 may secure its loan to a financial asset service provider 30 by retaining a security interest in the value of financial asset service agreement 160. In another embodiment of the present invention, financing may be obtained by financial asset services provider 30 selling the financial asset services agreement in exchange for capital approximately in the amount of the expected value of financial asset services agreement 160.

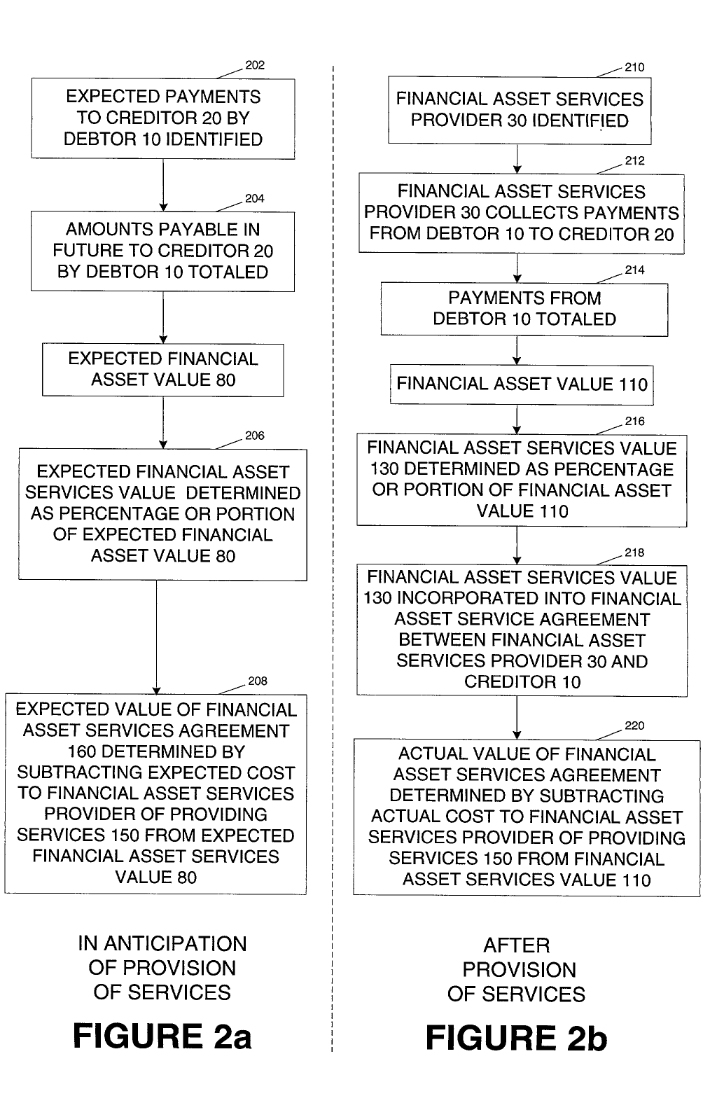

FIG. 2a is a flow chart of a method according to an embodiment of the present invention, whereby the system of FIG. 1 may be implemented in anticipation of a financial asset services agreement. At step 202, a debtor 20 and creditor 10 are identified and any amounts payable in the future to creditor 10 by debtor 20 are identified. Amounts payable in the future to creditor 20 by debtor 10 may include principal and interest. At step 204, amounts payable in the future to creditor 20 by debtor 10 are totaled. This sum is the expected financial asset value 80.

At step 206, the expected financial asset services value 160 may be determined as a percentage or portion of the expected financial asset value 80. At step 208, the expected value of a financial asset services agreement 160 may be determined by subtracting the expected cost to a financial asset services provider 30 of providing services 150 from an expected financial asset services value 80.

According to an embodiment of the invention, the financial asset service provider 30 may seek capital 170 from a lender 40. According to an embodiment of the invention, the availability of capital 170 from lender 40 may depend upon the expected value of assets of the financial service provider 30. One of those assets may be the value of a financial asset service agreement 160. According to an embodiment of the invention, at step 206 an expected financial asset services value 130 may be determined as a percentage or portion of expected financial asset value 80. According to an embodiment of the invention, at step 208 an expected value of a financial asset services agreement 160 may be determined by subtracting the expected cost to financial asset services provider of providing services 150 from expected financial asset services value 130.

FIG. 2b is a flow chart of a method according to an embodiment of the present invention, whereby the system of FIG. I may be implemented after performance of a financial asset services agreement. At step 210, according to a preferred embodiment of the invention, a financial asset services provider 30 is identified. A financial asset services provider 30 may be responsible for calculating payments due from debtor 20 to creditor 10, collecting all payments due from debtor 20 to creditor 10, accounting for payments of debtor 20 to creditor 10, paying taxes on behalf of debtor 20, maintaining insurance policies in connection with the loan, and advancing creditor 10 funds for failures of debtor 20 to make payments due under the loan. According to a preferred embodiment of the invention, at step 212 a financial services provider 30 collects actual payments from debtor 20 to creditor 10. At step 214, payments from debtor 20 to creditor 10 may be totaled. This sum is the actual financial asset value 110.

At step 216, the financial asset services value 130 may be determined as a percentage or portion of the financial asset value 110. According to a preferred embodiment of the present invention, at step 218, the financial asset services value 130 as calculated may be paid to the financial asset services provider 30 as agreed upon in the financial asset services agreement. At step 220, the actual value of a financial asset services agreement may be determined by subtracting the actual cost to a financial asset services provider of providing services 150 from the financial asset services value 110.

The resulting financial asset services value 130 and the value of financial asset services agreement 160 remain variables of the amounts due under the loan. However, because the financial asset services provider 30 also receives a percentage of principal payments made 90 the values are not reduced as drastically with the invention as they would be under present systems and methods when a debtor 20 pays off substantial portions of principal prematurely as interest rates drop. Therefore the financial asset services value 130 and the value of the financial asset services agreement 160 are more predictable, more stable and more readily characterized as an asset under the present invention.

While the foregoing description includes details and specificities, it should be understood that such details and specificities have been included for the purposes of explanation only, and are not to be interpreted as limitations of the present invention. Many modifications to the embodiments described above can be made without departing from the spirit and scope of the invention, as it is intended to be encompassed by the following claims and their legal equivalents.

What is claimed is:

1. A system for valuing financial asset services comprising:
a financial asset valuation component for determining a financial asset value by adding a total amount paid in the past and a total amount payable in the future by at least one debtor to at least one creditor in connection with a single financial account;
a servicing component for providing financial asset services by creating a service provider who is responsible for at least collection of a plurality of payments from the debtor and for making a plurality of payments to the creditor in connection with the single financial account; and
a financial asset service valuation component for determining a financial asset services value as a percentage of the financial asset value.

2. A system according to claim 1 further comprising:
a financial asset service agreement valuation component for determining a value of an agreement to perform financial asset services in exchange for the financial asset services value wherein a cost of providing financial asset services is subtracted from the financial asset services value.

3. A method for valuing financial asset services comprising the steps of:
determining a financial asset value by totaling an amount paid in the past and an amount payable in the future by at least one debtor to at least one creditor in connection with a single financial account;
creating a service provider who is responsible for at least collection of a plurality of payments from the debtor and for making a plurality of payments to the creditor; and
determining a financial asset services value as a percentage of the financial asset value.

4. A method for valuing a financial asset service agreement comprising the steps of:
determining a financial asset value by totaling an amount paid in the past and an amount payable in the future by at least one debtor to at least one creditor in connection with a single financial account;
creating a service provider who is responsible for at least collection of a plurality of payments from the debtor and for making a plurality of payments to the creditor;
determining a financial asset services value as a percentage of the financial asset value;
determining a value of an agreement to perform financial asset services in exchange for the financial asset services value wherein a cost of providing financial asset services is subtracted from the financial asset services value.

5. The system for valuing financial asset services as claimed in claim 1 wherein said financial asset is a mortgage loan.

6. The system for valuing a financial asset service agreement as claimed in claim 2 wherein said financial asset is a mortgage loan.

7. The method for valuing financial asset services as claimed in claim 3 wherein said financial asset is a mortgage loan.

8. The method for valuing a financial asset service agreement as claimed in claim 4 wherein said financial asset is a mortgage loan.

9. The system for valuing financial asset services as claimed in claim 1 wherein said financial asset is a credit card account.

10. The system for valuing a financial asset service agreement as claimed in claim 2 wherein said financial asset is a credit card account.

11. The method for valuing financial asset services as claimed in claim 3 wherein said financial asset is a credit card account.

12. The method for valuing a financial asset service agreement as claimed in claim 4 wherein said financial asset is a credit card account.

13. The system for valuing financial asset services as claimed in claim 1 wherein each of the total amount paid in the past and the total amount payable in the future by the debtor to the creditor under the single financial account includes at least a principal amount and an interest amount.

14. The system for valuing a financial asset service agreement as claimed in claim 2 wherein each of the total amount paid in the past and the total amount payable in the future by the debtor to the creditor under the single financial account includes at least a principal amount and an interest amount.

15. The method for valuing financial asset services as claimed in claim 3 wherein each of the total amount paid in the past and the total amount payable in the future by the debtor to the creditor under the single financial account includes at least a principal amount and an interest amount.

16. The method for valuing a financial asset service agreement as claimed in claim 4 wherein each of the total amount paid in the past and the total amount payable in the future by the debtor to the creditor under the single financial account includes at least a principal amount and an interest amount.
